(19) United States
(12) Patent Application Publication
(10) Pub. No.: US 2012/0206660 A1
(43) Pub. Date: Aug. 16, 2012

(54) LIGHT SOURCE PACKAGE, ILLUMINATION DEVICE, DISPLAY DEVICE, AND TELEVISION RECEIVING DEVICE

(75) Inventor: Nobuhiro Kasai, Osaka-shi (JP)

(73) Assignee: SHARP KABUSHIKI KAISHA, Osaka-shi, Osaka (JP)

(21) Appl. No.: 13/502,161

(22) PCT Filed: Oct. 15, 2010
(86) PCT No.: PCT/JP2010/068110

§ 371 Date: Apr. 16, 2012

(30) Foreign Application Priority Data
Dec. 1, 2009 (JP) 2009-273589

(51) Int. Cl. H04N 5/66; G02F 1/1335; F21V 9/16; F21V 9/00; F21V 21/00; F21V 7/00

(52) U.S. Cl. 348/739; 362/382; 362/296.01; 362/84; 362/231; 362/249.01; 349/61; 348/E05.133

(57) ABSTRACT

An LED package (PG) includes: an LED chip (11); and a support base (15) which has a bottom surface (15B) and an inclined surface (15S) that is inclined with respect to the bottom surface (15B), and which supports the LED chip (11) at the inclined surface (15S).

### TECHNICAL FIELD

The present invention relates to a light source package included in a backlight unit (illumination device) incorporated in a liquid crystal display device (display device), to an illumination device itself, to a display device itself, and to a television receiving device itself that incorporates a display device.

### BACKGROUND ART

When a display panel of the non-luminous type, such as a liquid crystal display panel, is used, a backlight unit (illumination device) for supplying light (backlight) to the liquid crystal display panel is incorporated in a liquid crystal display device. The backlight unit incorporates a light source in one of various designs, of which one example is the direct-lit design.

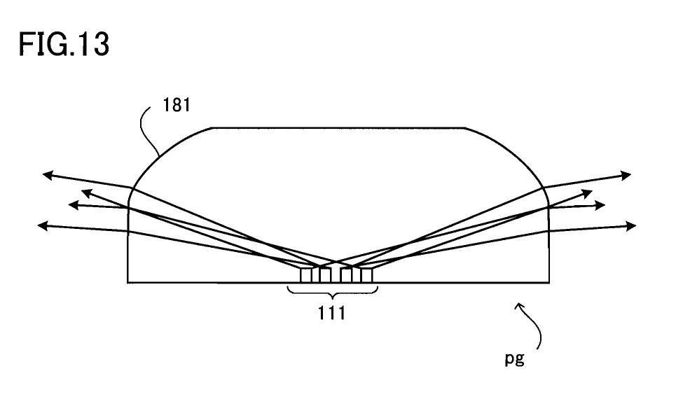

In the direct-lit design, for example, a plurality of LED (light-emitting diodes) chips are used. As one example, Patent Document 1 listed below discloses a backlight unit as shown in FIG. 13, where a microlens 181 that transmits light from an LED chip 111 is used, and the microlens 181 allows the light from the LED chip 111 to travel while diffusing in the desired directions.

When such LED chips 111 covered with microlenses 181 respectively (for convenience' sake, a package comprising a microlens 181 and an LED chip 111 will be referred to as an LED package pg) are arranged, for example, in a planar formation, the light from the plurality of LED packages mixes to produce planar light, which serves as backlight.

### LIST OF CITATIONS

### Patent Literature

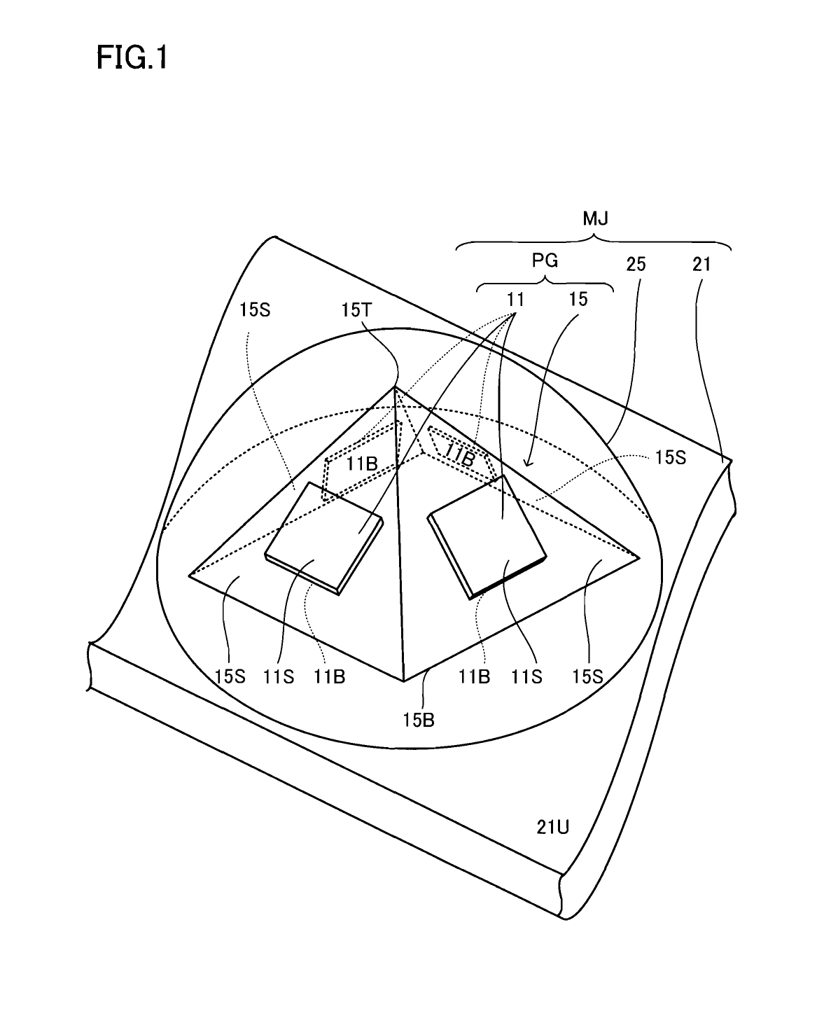

Patent Document 1: JP-A-2007-157686 (see FIG. 1)

### SUMMARY OF INVENTION

### Technical Problem

In the backlight unit described above, the light-diffusing function of the microlens 181 is exploited to produce planar light. To achieve that, the light of the LED chip (light-emitting chip) 111 has to enter the microlens 181 in an appropriate manner. In other words, the microlens 181 has to be arranged with consideration given to the direction of travel of the light of the LED chip 111.

This complicates the fabrication of the LED package (light source package) pg in the backlight unit above, and in addition the microlens 181 incurs extra cost, resulting in high cost (the complicated fabrication process, too, tends to increase the cost of the LED package pg).

The present invention has been made against the above background, and aims to provide a light source package that, despite being inexpensive, can produce high-quality planar light, an illumination device incorporating such a light source package, a display device incorporating such an illumination device, and a television receiving device incorporating such a display device.

### Solution To Problem

A light source package includes: a light-emitting chip as a light source; and a support base having a bottom face and an inclined face inclined relative to the bottom face, the support base supporting the light-emitting chip on the inclined face.

With this design, the light from the light-emitting chip arranged on the inclined face of the support base tends to travel in inclined directions relative to the bottom face of the support base. Thus, the light from the light-emitting chip does not travel perpendicularly to the bottom face of the support base, but travels in such a way as to approach the planar direction of the plane identical with the bottom face. Consequently, arranging a plurality of such light source packages in a planar formation increases the amount of light mixed, and produces high-quality planar light free from uneven light distribution as a whole.

Despite producing such high-quality planar light, the light source package does not require a special member, such as a microlens, for diffusing light in the planar direction of the plane identical with the bottom face of the support base. Omission of, for example, a microlens makes the light source package accordingly cheaper, and also eliminates the need for a process for covering the light-emitting chip with a microlens. This makes the light source package inexpensive and easy to fabricate.

The support base may have any of different shapes. For example, preferably, the support base has a tapered shape and has the inclined face as a side face (for example, a shape like a polygonal pyramid is preferred).

Preferably, the support base is a truncated polygonal pyramid in shape, and a light-emitting chip is arranged also on the top face, located at the top, of the truncated polygonal pyramid. With this design, the light-emitting chip arranged on the top face, too, permits adjustment of the amount of light.

Preferably, the support base having the tapered shape is so shaped that, with a central part of each side of the bottom face thereof moved inward, each inclined face is multiplied into a plurality of inclined faces.

Preferably, in the light source package, a reflective member is arranged so as to surround the support base, and the angle between the inner side face of the reflective member facing the support base and the normal line to the support face is in a relationship defined by formula (1) below

θ1<θ2 Formula (1)

where

θ1 represents, with respect to the reflective member, the angle of the inner side face relative to the bottom face of the reflective member which is on the same plane as the bottom face of the support base; and

θ2 represents, with respect to the support base, the angle of the normal line to the support face relative to the bottom face of the support base.

The light-emitting chip may be of any of different types, an example being an LED chip. And with an LED chip, the light source package may be implemented in any of different ways.

In one example, the LED chip is an LED chip that emits blue light or an LED chip that emits ultraviolet light, and the light source package further comprises a phosphor that, on receiving light from the LED chip, emits yellow fluorescence.

In another example, the LED chip is an LED chip that emits blue light, and the light source package further comprises a phosphor that, on receiving light from the LED chip, emits green and red fluorescence.

In yet another example, a plurality of LED chips arranged on the support base include an LED chip that emits red light and an LED chip that emits blue light, and the light source package further comprises a phosphor that, on receiving light from the LED chip that emits blue light, emits green fluorescence.

In still another example, a plurality of LED chips arranged on the support base include an LED chip that emits red light, an LED chip that emits green light, and an LED chip that emits blue light, and the light from those LED chips mixes to produce white light.

Preferably, the LED chip or chips arranged on each one of a plurality of inclined faces by themselves produce white light.

Also encompassed by the present invention is a light source module including: a light source package as described above; and a mount board on which the light source package is arranged. In such a light source module, preferably, a plurality of light source packages are arranged at equal intervals on the mount board.

Also encompassed by the present invention is an illumination device including a light source module as described above. In such an illumination device, preferably, a plurality of light source modules are arranged in a planar formation so that the light from them mixes to produce planar light.

Also encompassed by the present invention is a display device including: an illumination device as described above; and a display panel (for example, a liquid crystal display device) that receives light from the illumination device. Also encompassed by the present invention is a television receiving device including a display device as described above.

### Advantageous Effects of the Invention

A light source package according to the invention can supply light that allows easy production of high-quality planar light in an illumination device, and in addition contributes to low cost by being easy to fabricate and requiring no special member (such as a microlens).

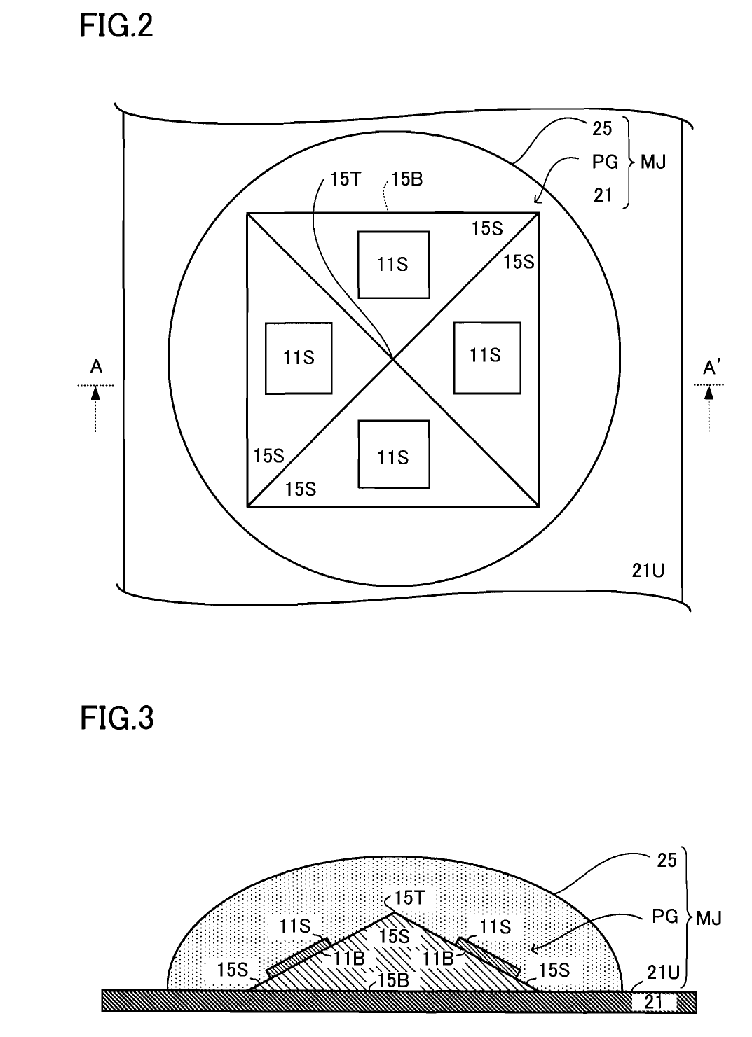

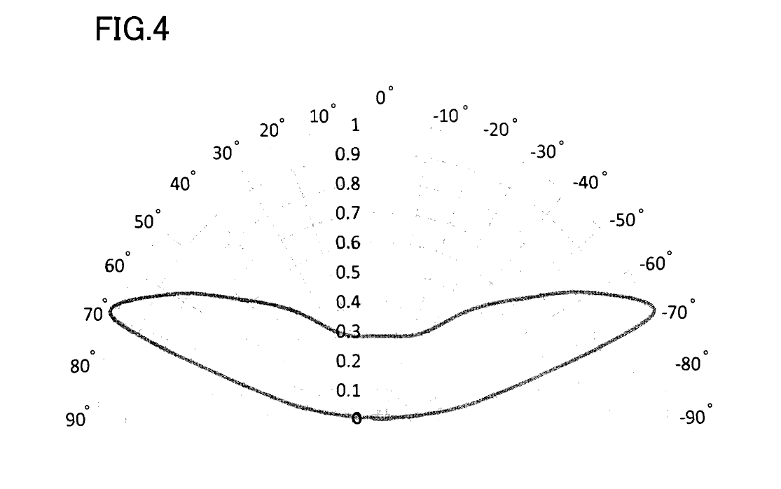

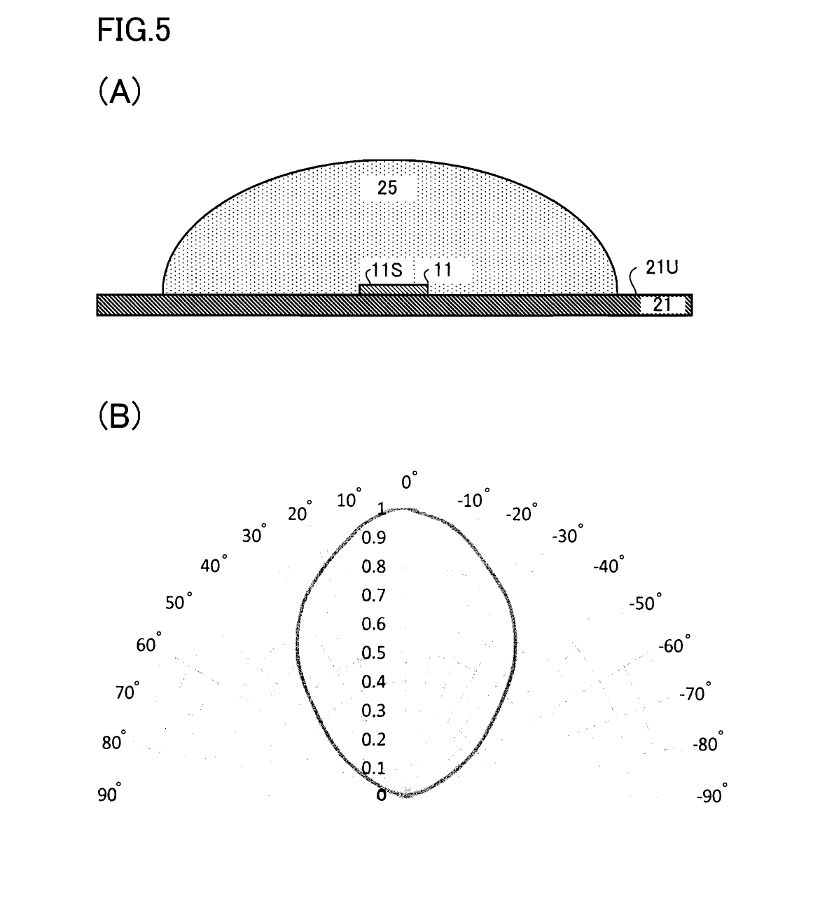

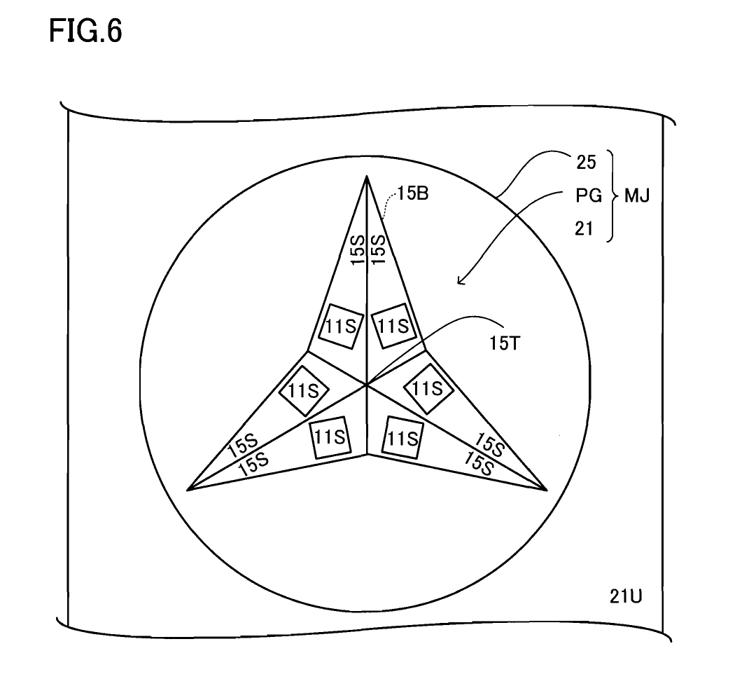

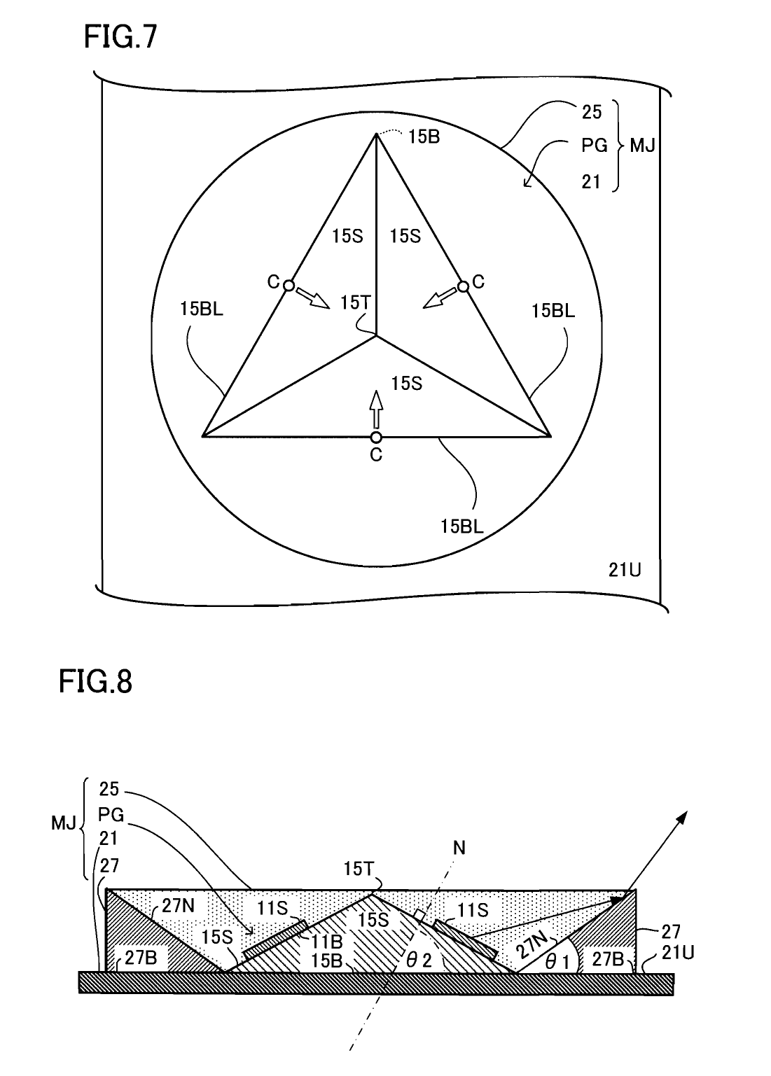

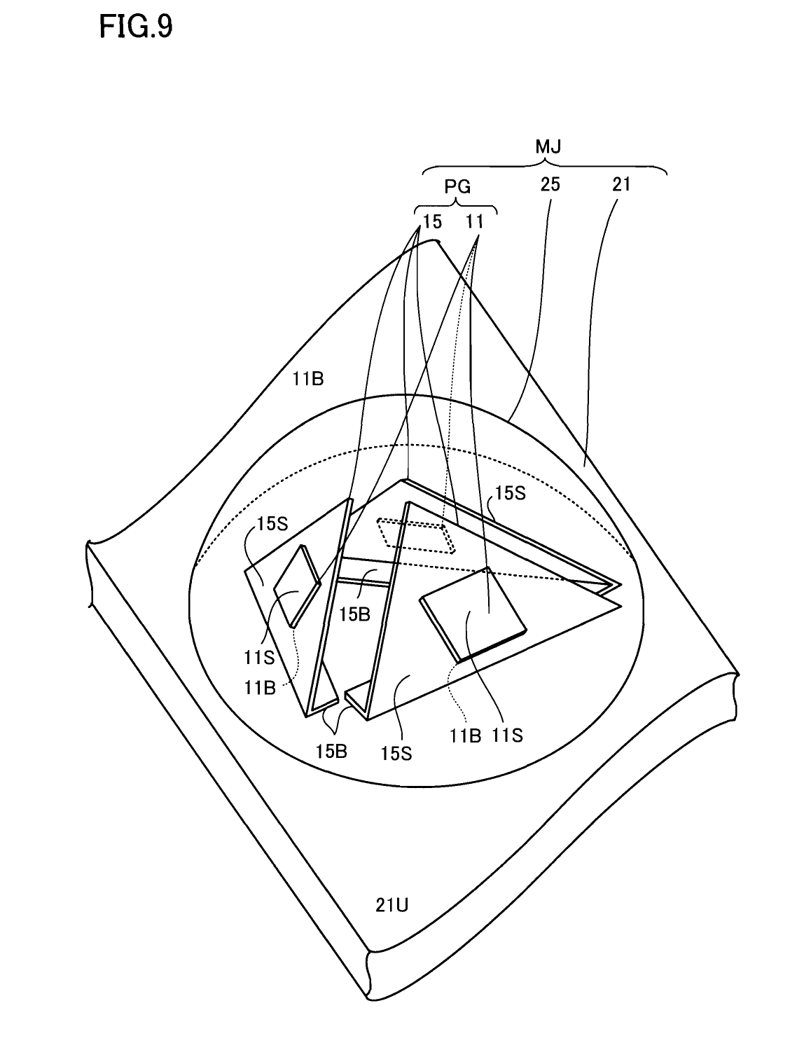

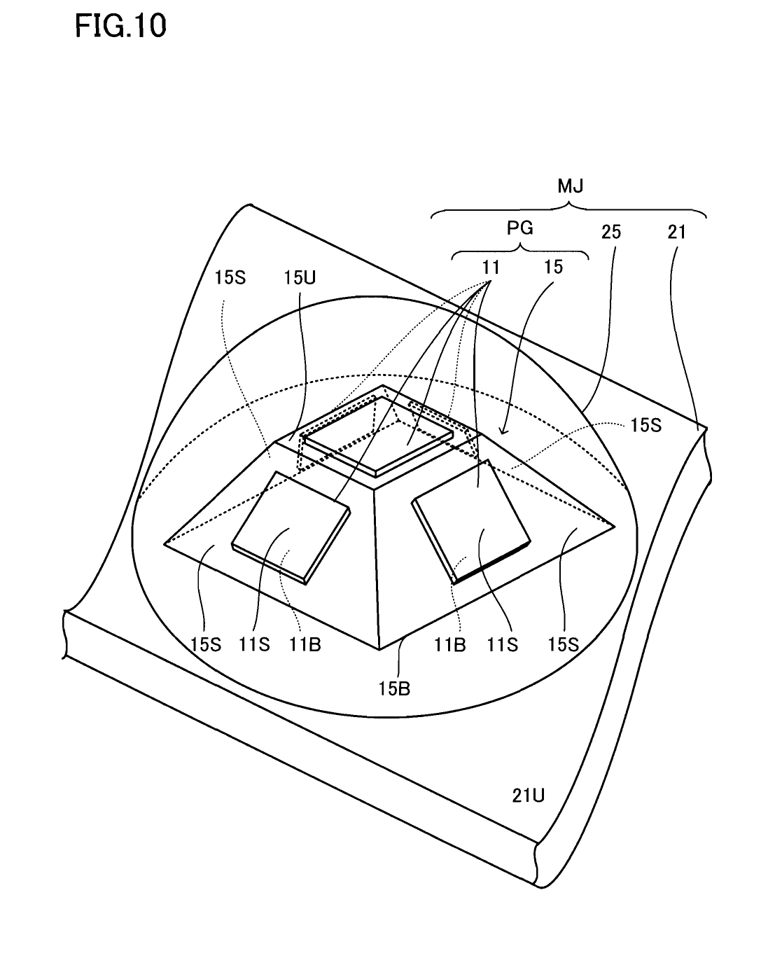

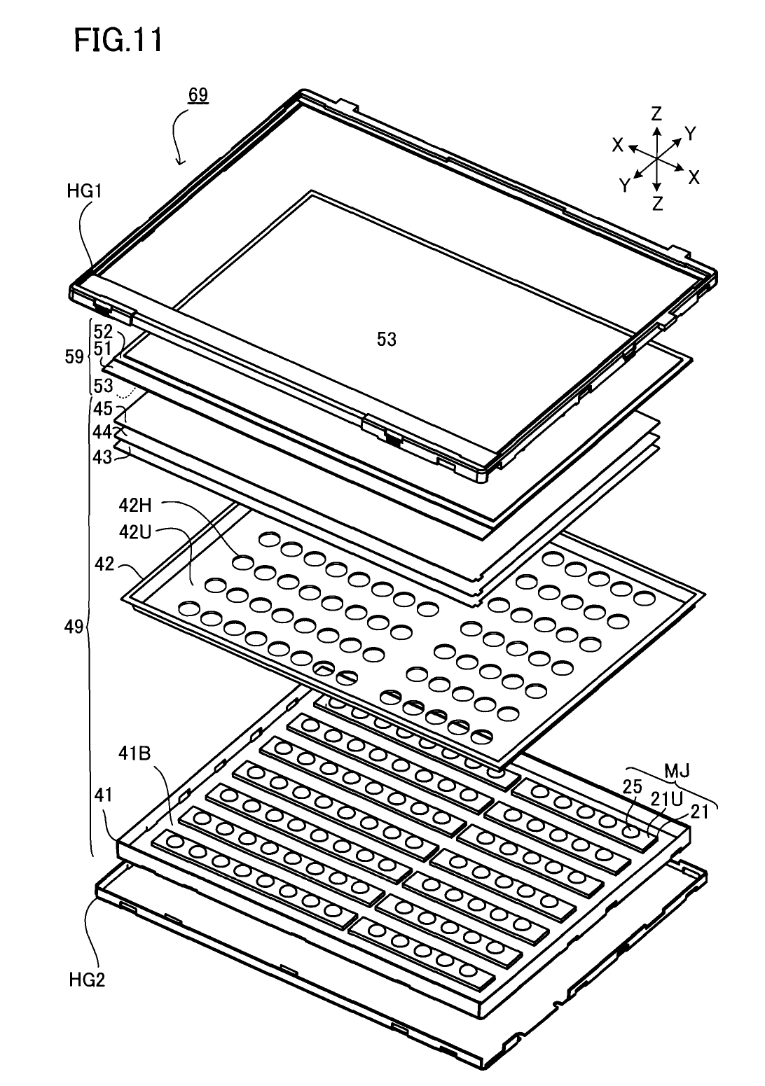

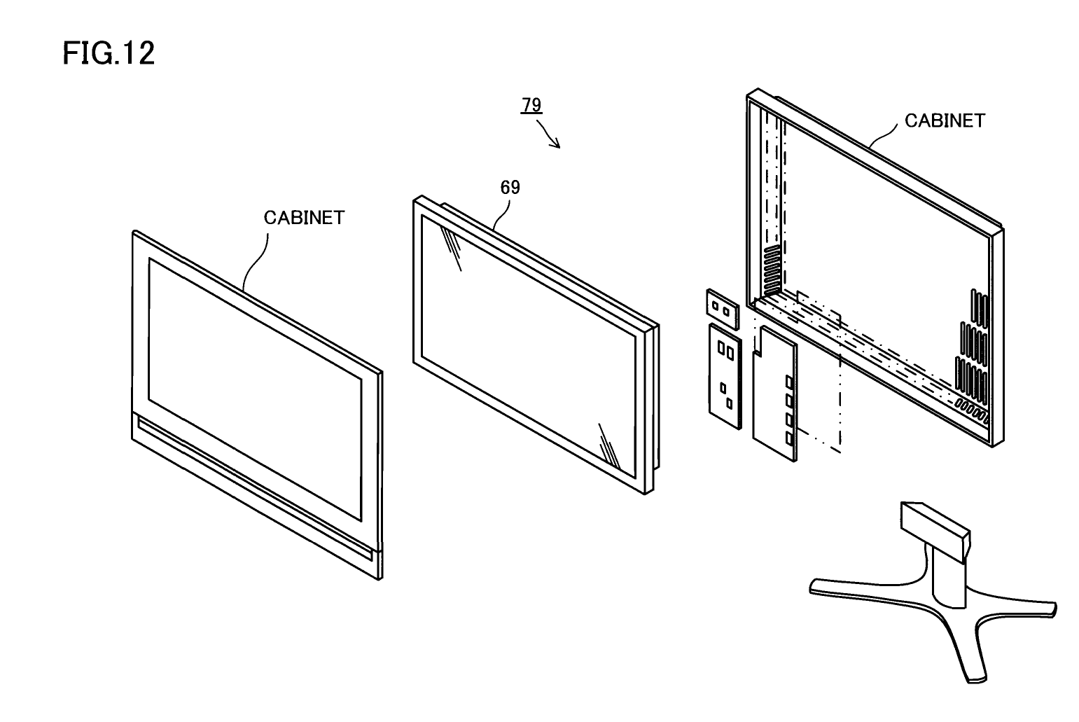

### BRIEF DESCRIPTION OF DRAWINGS

[FIG. 1] is a perspective view of an LED package including a support base in the shape of a quadrangular pyramid;

[FIG. 2] is a plan view of an LED package including a support base in the shape of a quadrangular pyramid;

[FIG. 3] is a sectional view of the LED package shown in FIG. 2 along line A-A′, as seen from the direction indicated by arrows;

[FIG. 4] is a graph showing the directivity of an LED package on a polar coordinate system;

[FIG. 5A] is a sectional view of an LED package as a comparison example;

[FIG. 5B] is a graph showing the directivity of an LED package as a comparison example on a polar coordinate system;

[FIG. 6] is a plan view of an LED package including a support base having a special shape;

[FIG. 7] is a perspective view of an LED package including a support base in the shape of a triangular pyramid;

[FIG. 8] is a sectional view of an LED package including a reflector;

[FIG. 9] is a perspective view of an LED package including a plurality of support bases in the shape of a plate;

[FIG. 10] is a perspective view of an LED package including a support base in the shape of a truncated quadrangular pyramid;

[FIG. 11] is an exploded perspective view of a liquid crystal display device;

[FIG. 12] is an exploded perspective view of a television receiving device incorporating a liquid crystal display device; and

[FIG. 13] is a sectional view of an LED package incorporated in a conventional backlight unit.

### DESCRIPTION OF EMBODIMENTS

### Embodiment 1

An embodiment of the present invention will be described below with reference to the accompanying drawings. For convenience' sake, hatching and reference signs are occasionally omitted, in which case other relevant drawings are to be referred to.

FIG. 12 shows an LCD (liquid crystal display) television 79 incorporating a liquid crystal display device (display device) 69. The LCD television 79 is of the type that receives television broadcast signals and displays images, and thus can be said to be a television receiving device. FIG. 11 is an exploded perspective view of the liquid crystal display device 69. As shown in FIG. 11, the liquid crystal display device 69 includes a liquid crystal display panel (display panel) 59, a backlight unit (illumination device) 49 which supplies light to the liquid crystal display panel 59, and a housing HG (a front housing HG1 and a rear housing HG2) in which those are housed.

The liquid crystal display panel 59 is composed of an active matrix substrate 51, which includes switching devices such as TFTs, and a counter substrate 52, which is disposed opposite the active matrix substrate 51, bonded together with a sealing member (not shown). The gap between the two substrates 51 and 52 is filled with liquid crystal (not shown).

The active matrix substrate 51 is, on its light-entrance side, fitted with a polarizing film 53, and the counter substrate 52 is, on its light-exit side, fitted with a polarizing film 53. Structured as described above, the liquid crystal display panel 59 displays an image by exploiting variation of transmittance resulting from inclination of liquid crystal molecules.

Next, a description will be given of the backlight unit 49, which is located immediately behind the liquid crystal display panel 59. The backlight unit 49 includes LED modules (light source modules) MJ, a backlight chassis 41, a reflective sheet 42, a diffusive plate 43, a prism sheet 44, and a lens sheet 45.

As shown in a perspective view in FIG. 1, which is an enlarged view of part of FIG. 11, in FIG. 2, which is a plan view of FIG. 1, and in FIG. 3, which is a sectional view of FIG. 2 (cut along line A-A′ in FIG. 2 and viewed from the direction indicated by arrows), each LED module MJ includes LED chips (light-emitting chips) 11, a support base 15, a mount board 21, and a sealing member 25.

The LED chips 11 are each a chip of a light-emitting device which serves as a light source, emitting light approximately perpendicularly to its own light emission face 11S. The support base 15 is a base which supports LED chips 11 (the support base 15 will be described in detail later). Each LED chip 11 is, at its bottom face which expands in the same direction as its light emission face 11S (that is, the face opposite from the light emission face 11S), attached to the support base 15, and thereby the LED chip 11 is arranged on the support base 15. A support base 15 along with a plurality of LED chips 11 arranged on it thus constitutes an integral package, which will be referred to as an LED package PG.

The mount board 21 is a rectangular, plate-shaped board, and on its mount face 21U, a plurality of electrodes (not shown) are arranged. On these electrodes, via the support base 15, the LED chips 11 are attached. The electrodes and the LED chips 11 are electrically connected together, for example, by wire bonding.

On the mount face 21U of the mount board 21, a resist film (not shown) is formed which serves as a protective film. The resist film is preferably, but not limited to, a reflective white color. The reason is that then, even when light strikes on the resist film, the light is reflected by the resist film to head outside; this helps eliminate the cause of uneven light distribution resulting from absorption of light by the mount board 21.

The backlight unit 49 shown in FIG. 11 incorporates shorter mount boards 21, on each of which five LED packages PG are mounted in a row, and longer mount boards 21, on each of which eight LED packages PG are mounted in a row (see the sealing members 25 covering the LED packages PG).

The two types of mount boards 21 are arranged such that a row of five LED packages PG and a row of eight LED packages PG together form a row of 13 LED packages PG; the two types of mount boards 21 are arranged also side by side in a direction crossing (for example, perpendicular to) the direction in which 13 LED packages PG are arranged in a row (preferably, the LED packages PG are arranged at equal intervals).

Thus, the LED packages PG are arranged in a matrix-like formation (put another way, the LED modules MJ are arranged in a planar formation), and the light from those LED packages PG mixes to produce planar light (for convenience' sake, the direction in which mount boards 21 of different types are arranged will be referred to as the X direction, the direction in which mount boards 21 of the same type are arranged will be referred to as the Y direction, and the direction crossing both the X and Y directions will be referred to as the Z direction).

As shown in FIGS. 1 to 3, the sealing member 25 is a material that seals LED chips 11 and a support base 15 supporting them into place on the mount face 21U of the mount board 21. The sealing member 25 transmits light (transparent or translucent) so as to let the light from the LED chips 11 travel outside without intercepting it.

As shown in FIG. 11, the backlight chassis 41 is, for example, a box-shaped member, and houses, in a form spread across its bottom face 41B, a plurality of LED modules MJ. The bottom face 41B of the backlight chassis 41 and the mount boards 21 of the LED modules MJ are fastened together by unillustrated rivets.

On the bottom face 41B of the backlight chassis 41, support pins for supporting the diffusive plate 43, the prism sheet 44, and the lens sheet 45 may be fitted (the backlight chassis 41 may, with an inclination of its own side walls in combination with such support pins, support the diffusive plate 43, the prism sheet 44, and the lens sheet 45 in a form stacked together in this order).

The reflective sheet 42 is an optical sheet having a reflective face 42U, and covers a plurality of LED modules MJ, with the reverse face of the reflective face 42U facing them. The reflective sheet 42 has through holes 42H at positions corresponding to the sealing members 25 covering the LED packages PG so that the LED packages PG and the sealing members 25 are exposed through the reflective face 42U (further holes may be formed to expose the above-mentioned rivets and support pins as well).

Thus, even when part of the light emanating from the LED packages PG travels toward the bottom face 41B of the backlight chassis 41, the reflective face 42U of the reflective sheet 42 reflects it to make it travel away from the bottom face 41B. The presence of the reflective sheet 42 therefore allows the light from the LED packages PG to travel, without loss, toward the diffusive plate 43 facing the reflective face 42U.

The diffusive plate 43 is an optical sheet that is stacked over the reflective sheet 42, and diffuses the light emanating from the LED modules MJ and the light reflected from the reflective sheet 42U. That is, the diffusive plate 43 diffuses the planar light formed by the plurality of LED modules MJ (put another way, the plurality of LED packages PG arranged in a matrix-like formation) to make it illuminate the entire area of the liquid crystal display panel 59.

The prism sheet 44 is an optical sheet that is stacked over the diffusive plate 43. The prism sheet 44 has, for example, triangular prisms extending in one direction (linearly) arranged side by side in a direction crossing that one direction, across the plane of the sheet. Thus, the prism sheet 44 alters the radiating characteristics of the light from the diffusive plate 43. Preferably, the prisms extend in the Y direction, in which less LED packages PG are arranged, and are arranged side by side in the X direction, in which more LED packages PG are arranged.

The lens sheet 45 is an optical sheet that is stacked over the prism sheet 44. The lens sheet 45 has, dispersed in it, fine particles that refract and scatter light. Thus, the lens sheet 45 prevents the light from the prism sheet 44 from converging locally, and thereby lessens luminance differences (uneven light distribution).

With the backlight unit 49 structured as described above, the planar light formed by the plurality of LED modules MJ is passed through the plurality of optical sheets 43 to 45 and is supplied to the liquid crystal display panel 59. Receiving the light (backlight) from the backlight unit 49, the liquid crystal display panel 59 offers improved display performance.

Now, the support base 15 in the LED package PG will be described in detail with reference to FIGS. 1 to 3. As shown in FIGS. 1 and 2, the support base 15 has the shape of a quadrangular pyramid; it has a bottom face 15B, at which it makes contact with the mount face 21U of the mount board 21, and four inclined faces (support faces) 15S. On these four inclined faces 15S, LED chips 11 are attached (each LED chip 11 is, at its bottom face 11B which expands in the same direction as its light emission face 11S, attached to an inclined face 15S of the support base 15, and thereby the LED chip 11 is arranged on the inclined face 15S of the support base 15).

When LED chips 11 are attached to the support base 15 in this way, then, as shown in FIG. 2, the LED chips 11 are arranged in an annular formation about the vertex 15T of the support base 15. In addition, the LED chips 11 are arranged on the inclined faces 15S of the support base 15, and thus they emit light not perpendicularly to but with inclinations relative to the mount face 21U (put another way, the bottom face 15B of the support base 15).

Thus, the light from the LED chips 11 arranged on the inclined faces (side faces) 15S of the support base 15 tends to travel in inclined directions relative to the bottom face 15B of the support base 15. Accordingly, the light from the LED chips 11 does not travel perpendicularly to the bottom face 15B, but travels in such a way as to approach the planar direction of the plane (that is, the mount face 21U) identical with the bottom face 15B.

Then, the LED package PG has directivity (angular distribution of light) as shown in a polar coordinate system in FIG. 4 (the FIGS. 0 to 1 on the vertical scale are relative values of light intensity). That is, the LED package PG does not emit light in directions approximately perpendicular (at about 0°) to the mount face 21U but emits light in such a way that it approaches the mount face 21U.

For example, in a case where, as shown in FIG. 5A, an LED chip 11 has its light emission face 11S expanding parallel to the mount face 21U of the mount board 21, then directivity as shown in FIG. 5B is obtained (it should be noted that the LED package PG shown in FIG. 5A is an example for comparison). That is, light is emitted approximately perpendicularly (at about 0°) to the mount face 21U. By contrast, in the LED package PG, the LED chips 11 are arranged on the inclined faces 15S of the support base 15 of which the bottom face 15B is in intimate contact with the mount face 21U, and are thus inclined relative to the mount face 21U. As a result, the LED package PG has directivity as shown in FIG. 4.

In addition, where LED packages (light source packages) PG with such directivity are arranged in a matrix-like formation (in a planar formation), the light from the plurality of LED packages PG mixes over a wide area (that is, more light mixes) to produce high-quality planar light (backlight) free from uneven light distribution. In particular, arranging the LED packages PG at equal intervals helps light mix evenly, and thus the light from the backlight unit 49 is less likely to suffer from uneven light distribution.

Moreover, simply including the sealing member 25, the LED package PG does not require a special optical member such as a microlens for diffusing the light of each LED packages PG. Omitting a microlens reduces the cost of the LED package PG accordingly. Moreover, now that no transmission through a microlens is involved, the LED package PG provides an increased amount of light (hence, it produces high-luminance planar light at a comparatively low electric power).

Generally, in a case where a microlens is arranged for each light source (for example, LED chip 11), it is necessary to align the lens center with the optical axis of the light source, and this complicates the fabrication of the LED package. By contrast, the LED package PG shown in FIGS. 1 to 3 does not require such a complicated fabrication process; in addition, it is free from faults such as the microlens coming off.

Although the above description mentions, as an example of the tapering shape of the support base 15, a quadrangular pyramid, this is not meant to be any limitation. For example, the shape of the support base 15 may be any polygonal pyramid other than quadrangular, such as a triangular or pentagonal pyramid, or may be a circular cone (that is, the support base 15 has simply to be a pyramidal member). The support base 15 may even be in the shape of a truncated pyramid.

The support base 15 may be shaped as shown in a plan view in FIG. 6. Specifically, the support base 15 there can be said to be shaped as follows: in a support base 15 in the shape of a triangular pyramid as shown in a plan view in FIG. 7, a central part C, not necessarily the exact center, of each perimetric side 15BL of its bottom face 15B is moved inward (see the hollow arrows) such that each of the three inclined faces 15S of the support base 15 in the shape of a triangular pyramid is divided into two inclined faces 15S, with the result that there are a total of six inclined faces 15S (for convenience' sake, LED chips 11 are omitted in FIG. 7). For convenience' sake, this shape is referred to as a three-point start.

That is, a support base 15 having a tapered shape is so shaped that a central part of each perimetric side 15BL of its bottom face 15B is moved inward such that each inclined face 15S is multiplied into a plurality of inclined faces 15S. Also with a so shaped support base 15, when LED chips 11 are arranged on the inclined faces 15S, the light from those LED chips 11 is inclined relative to the mount face 21U. Consequently, the light from the LED package PG has such directivity as to travel radially with respect to the vertex 15T of the support base 15 and approach the mount face 21U.

### Embodiment 2

A second embodiment of the present invention will be described below. Such members as function similarly to their counterparts in Embodiment 1 will be identified with the same reference signs, and no overlapping description will be repeated.

Embodiment 1 deals with, as an example, an LED package PG that includes at least LED chips 11 and a support base 15. An LED package PG may include any other member, for example a reflector (reflective member) 27. An example is an LED package PG as shown in a sectional view in FIG. 8 (showing a section similar to that in FIG. 3).

Specifically, the reflector 27 has a shape (for example, annular) such that it can surround the support base 15, and has the function of reflecting light at its inner side face 27N facing the support base 15. With this design, of the light from the LED chips 11, for example, a peripheral part (not light perpendicular to the light emission face 11S of the LED chips 11 but light approaching the light emission face; see the solid-line arrows) is reflected on the inner wall face 27V. With this design, less light approaches the mount face 21U so much as not to reach the liquid crystal display panel 59. That is, loss of light is reduced

As shown in FIG. 8, the reflector 27 is arranged so as to surround the support base 15, and in the reflector 27, it is preferable that the angle between the inner side face 27N facing the support base 15 and the normal line N to the inclined faces 15S of the support base 15 be in a relationship defined by Formula (1) noted below (incidentally, it is preferable that, compared with the height of the support base, that is, the shortest length from the bottom face 15B to the vertex 15T, the height of the reflector 27, that is, the shortest length from its bottom face 27B to the top of the inner wall face 27N, be equal or more.

θ1<θ2 Formula (1)

where

θ1 represents, with respect to the reflector 27, the angle of the inner side face 27N relative to the bottom face 27B, which is located on the same plane as the bottom face 15B of the support base 15 (being the angle between the inner side face 27N and the bottom face 27B inside the reflector 27); and

θ2 represents, with respect to the support base 15, the angle of the normal line N to the inclined faces 15S relative to the bottom face 15B of the support base 15 (θ2 being an acute angle).

So long as Formula (1) is fulfilled, when LED chips 11 are arranged on the inclined faces 15S of the support base 15, even if light of the maximum intensity travels approximately perpendicularly to the light emission faces 11S of those LED chips 11, it does not occur that the light is reflected on the inner side face 27N of the reflector 27 to travel in such a way as to approach the direction perpendicular to the mount face 21U (thus, by preventing refraction of light of the maximum intensity, loss of light is prevented). Accordingly, the light with high intensity from the LED chips 11 is not reflected on the reflector 27 but mixes to produce high-luminance planar light

### Other Embodiments

The present invention is not limited by any of the embodiments and examples specifically described above, and allows many modifications and variations without departing from its spirit.

For example, as shown in FIG. 9, the support base 15 may be in the form of a plate. Specifically, the support base 15 may be formed as follows: a triangular plate is bent along one side, parallel to it, to produce a quadrilateral portion so that this portion serves as the bottom face 15B and the rest, the triangular portion, serves as an inclined face 15S (the minimum angle between the bottom face 15B and the inclined face 15S is an acute angle; the face of the bottom face 15B and the face of the inclined face 15S at which they face each other are referred to as their reverse faces, and the face of the bottom face 15B and the face of the inclined face 15S opposite from their reverse faces are referred to as their obverse faces).

Also this support base 15 has a bottom face 15B and an inclined face 15S inclined relative to the bottom face 15B. Thus, when an LED chip 11 is arranged on the inclined face 15S (more specifically, the obverse face of the inclined face 15S), the light from the LED chip 11 tends to travel in inclined directions relative to the bottom face 15B.

Moreover, as shown in FIG. 9, when support bases 15 in the form of a plate are arranged in an annular formation with the obverse faces of the inclined faces 15S facing outward of the ring, the light emission faces 11S of the LED chips 11 arranged on the obverse faces of the inclined faces 15S face outward of the ring as well, and allow light to spread radially. That is, also with an LED package PG that includes a plurality of plate-form support bases 15 having LED chips 11 arranged on them, similar workings and effects are achieved as with an LED package PG including a pyramidal support base 15 as shown in FIG. 1 (that is, an LED package PG in which a plurality of inclined faces 15S are arranged in an annular formation and LED chips 11 are arranged on those inclined faces 15S so that annular light is emitted outside).

The support base 15 may be, as mentioned above, in the shape of a truncated pyramid, in which case, as shown in FIG. 10 which shows a support base 15 in the shape of a truncated quadrangular pyramid as an example of a truncated pyramid, an LED chip 11 may also be arranged on the top face 15U of the support base 15 (the top face 15U being the face located on the tapering side of the support base 15 (the face opposite from the bottom face 15B of the support base 15) and the face, like the bottom face 15B, surrounded by the inclined faces 15S).

When an LED chip 11 is arranged on the top face 15U of such a support base 15, the LED chip 11 functions as a light source for correcting uneven luminance in the direction perpendicular to (ahead of) the mount face 21U of the mount board 21. This helps more reliably eliminate uneven light distribution in the planar light (backlight) from the backlight unit 49.

There is no particular limitation on the color of the light emitted by the LED package PG; it may emit light of, for example, red, green, blue, white, or any other color. The LED package PG may incorporate a phosphor (a fluorescent or phosphorescent substance) (as in a case where the sealing member 25 contains a phosphor) so that the light from an LED chip 11 and the fluorescent light excited by the light from an LED chip 11 mix to produce white light.

Specifically, for example, the LED package PG may be one including an LED chip 11 that emits blue light (or an LED chip 11 that emits ultraviolet light) along with a phosphor that, on receiving the light from the LED chip 11, emits yellow fluorescence and. This LED package PG produces white light by mixing the blue light from the LED chip 11 with the fluorescence.

The phosphor incorporated in the LED package PG is not limited to one emitting yellow fluorescence. For example, the LED package PG may instead be one including an LED chip 11 that emits blue light along with a phosphor that, on receiving the light from the LED chip 11, emits green and red fluorescence so that the blue light from the LED chip 11 and the fluorescence (green and red light) mix to produce white light.

The LED chip 11 incorporated in the LED package PG is not limited to one emitting blue light. For example, the LED package PG (put another way, the plurality of LED chips 11 arranged on the support base 15) may instead be one including an LED chip 11 that emits red light and an LED chip 11 that emits blue light along with a phosphor that, on receiving the light from the blue LED chip 11, emits green fluorescence. With this LED package PG, the red light from the red LED chip 11, the blue light from the blue LED chip 11, and the green fluorescence mix to produce white light.

The LED package PG may be one that includes no phosphor at all. For example, the plurality of LED chips 11 arranged on the support base 15 may include an LED chip 11 that emits red light, an LED chip 11 that emits green light, and an LED chip 11 that emits blue light so that the light from all these LED chips 11 mix to produce white light.

There is no particular limitation on the number of LED chips 11 arranged on each inclined face 15S of the support base 15. It is, however, preferable that each one of the plurality of inclined faces 15S of the support base 15 has such LED chips 11 arranged on it as can produce white light by themselves. With this design, the light (backlight) emitted from the backlight unit 49 tends to be high-quality light free from color unevenness.

### LIST OF REFERENCE SIGNS

PG LED package (light source package)

11 LED chip (light-emitting chip)

11S light emission face of LED chip

11B bottom face of LED chip

15 support base

15S inclined face of support base (support face)

15B bottom face of support base

15BL side of bottom face of support base

15T vertex of support base

15U top face of support face

21 mount board

21U mount face

25 sealing member

MJ LED module (light source module)

27 reflector (reflective member)

27N inner side face of reflector

27B bottom face of reflector

MJ LED module

41 backlight chassis

42 reflective sheet

43 diffusive plate

44 prism sheet

45 lens sheet

49 backlight unit (illumination device)

59 liquid crystal display panel (display panel)

69 liquid crystal display device (display device)

70 LCD television (levis ion receiving device)

1. A light source package comprising:
a light-emitting chip as a light source; and
a support base having a bottom face and an inclined face inclined relative to the bottom face, the support base supporting the light-emitting chip on the inclined face.

2. The light source package according to claim 1, wherein the support base has a tapered shape and has the inclined face as a side face.

3. The light source package according to claim 1, wherein the support base is a polygonal pyramid in shape.

4. The light source package according to claim 1, wherein
the support base is a truncated polygonal pyramid in shape, and
a light-emitting chip is arranged also on a top face, located at a top, of the truncated polygonal pyramid.

5. The light source package according to claim 2, wherein the support base having the tapered shape is so shaped that, with a central part of each side of the bottom face thereof moved inward, each inclined face is multiplied into a plurality of inclined faces.

6. The light source package according to claims 1, wherein
a reflective member is arranged so as to surround the support base, and
an angle between an inner side face of the reflective member facing the support base and a normal line to the support face is in a relationship defined by formula (1) below
θ1<θ2 Formula (1)
where
θ1 represents, with respect to the reflective member, an angle of the inner side face relative to a bottom face of the reflective member which is on a same plane as the bottom face of the support base; and
θ2 represents, with respect to the support base, an angle of the normal line to the support face relative to the bottom face of the support base.

7. The light source package according to claim 1, wherein the light-emitting chip is an LED chip.

8. The light source package according to claim 7, wherein
the LED chip is an LED chip that emits blue light or an LED chip that emits ultraviolet light, and
the light source package further comprises a phosphor that, on receiving light from the LED chip, emits yellow fluorescence.

9. The light source package according to claim 7, wherein
the LED chip is an LED chip that emits blue light, and
the light source package further comprises a phosphor that, on receiving light from the LED chip, emits green and red fluorescence.

10. The light source package according to claim 7, wherein
a plurality of said LED chip arranged on the support base include an LED chip that emits red light and an LED chip that emits blue light, and
the light source package further comprises a phosphor that, on receiving light from the LED chip that emits blue light, emits green fluorescence.

11. The light source package according to claim 7, wherein a plurality of said LED chip arranged on the support base include an LED chip that emits red light, an LED chip that emits green light, and an LED chip that emits blue light, and light from the LED chips mixes to produce white light.

12. The light source package according to claim 7, wherein the LED chip or chips arranged on each one of a plurality of the inclined face by themselves produce white light.

13. A light source module comprising:
the light source package according to claim 1; and
a mount board on which the light source package is arranged.

14. The light source module according to claim 13, wherein a plurality of said light source package are arranged at equal intervals on the mount board.

15. An illumination device comprising the light source module according to claim 13.

16. The illumination device according to claim 15, wherein a plurality of said light source module are arranged in a planar formation so that light therefrom mixes to produce planar light.

17. A display device comprising:
the illumination device according to claim 15; and
a display panel that receives light from the illumination device.

18. The display device according to claim 17, wherein the display panel is a liquid crystal display panel.

19. A television receiving device comprising the display device according to claim 17.
